(19) United States
(12) Patent Application Publication
(10) Pub. No.: US 2024/0283318 A1
(43) Pub. Date: Aug. 22, 2024

(54) MOTOR

(71) Applicant: NIDEC CORPORATION, Kyoto (JP)

(72) Inventors: Zezhong HAN, LIAONING (CN); Baojun LUAN, LIAONING (CN)

(73) Assignee: NIDEC CORPORATION, Kyoto (JP)

(21) Appl. No.: 18/443,327

(22) Filed: Feb. 16, 2024

(30) Foreign Application Priority Data
Feb. 17, 2023 (CN) 202310142368.0

(51) Int. Cl. H02K 3/52

(52) U.S. Cl. CPC H02K 3/522; H02K 2203/09

(57) ABSTRACT

A motor includes a busbar holder and a power terminal electrically connected to the busbar holder. The busbar holder has a hole accommodating an end of the power terminal. At least one portion of an inner wall of the hole is defined with an internal thread. At least one portion of the end of the power terminal is defined with an external thread. The power terminal and the busbar holder are connected by threaded fitting of the external thread and the internal thread. In this way, the power terminal and the busbar holder are connected through threaded fitting, so that the stability of the electrical connection between the power terminal and the busbar holder is improved, and the failure rate of the motor is thus decreased.

### CROSS REFERENCE TO RELATED APPLICATIONS

The present disclosure claims priority under 35 U.S.C. § 119 to Chinese Application No. 202310142368.0 filed on Feb. 17, 2023, the entire content of which is incorporated herein by reference.

### FIELD OF THE DISCLOSURE

The disclosure relates to the electromechanical field, and in particular, to a motor.

### BACKGROUND

Generally, a motor needs to be electrically connected to an external power source through a power terminal, so that various components in the motor are powered by the external power source.

In one common method, the power terminal is electrically connected to a busbar, and power from the external power source is supplied to the various components of the motor through the power terminal and the busbar. For instance, generally, the busbar is held in the motor by a busbar holder, the power terminal connected to the external power source is inserted into the busbar holder, and the power terminal and the busbar in the busbar holder are welded. In this way, the power terminal is fixed and electrically connected to the busbar.

However, since the power terminal and the busbar are fixed merely through welding, welding separation may easily occur during production or transportation, causing the power terminal to be detached from the busbar holder, and the failure rate of the motor may increase.

It should be noted that the above introduction to the technical background is only set forth to facilitate a clear and complete description of the technical solutions of the disclosure and to facilitate understanding of a person having ordinary skill in the art. It should not be considered that the above technical solutions are well-known to a person having ordinary skill in the art just because these solutions are described in the BACKGROUND section of the disclosure.

### SUMMARY

In order to solve the abovementioned problem or other similar problems, the exemplary embodiments of the disclosure provide a motor.

According to the first aspect of the exemplary embodiments of the disclosure, a motor is provided, and the motor includes a busbar holder and a power terminal electrically connected to the busbar holder. The busbar holder has a hole accommodating an end of the power terminal. At least one portion of an inner wall of the hole is defined with an internal thread. At least one portion of the end of the power terminal is defined with an external thread. The power terminal and the busbar holder are connected by threaded fitting of the external thread and the internal thread.

In this way, the power terminal is prevented from being detached from the busbar holder through the threaded fitting between the power terminal and the busbar holder.

In at least one exemplary embodiment, the busbar holder includes a busbar and a resin portion wrapping the busbar. The hole is at least defined at the busbar, and a portion of the inner wall of the hole located at the busbar is defined with the internal thread.

In this way, the power terminal is prevented from being detached from the busbar holder at least through the threaded fitting between the busbar and the power terminal.

In at least one exemplary embodiment, the resin portion has a base wrapping the busbar and a cylindrical portion extending from the base in an axial direction. The hole includes a first hole defined in the busbar and a second hole defined in the cylindrical portion. The first hole and the second hole pass through in the axial direction. An inner wall of the first hole is defined with the internal thread.

In this way, since the first hole of the busbar is welded and fixed to the power terminal and the cylindrical portion is used to keep the power terminal from shifting and shaking in the axial direction, the power terminal is further prevented from being detached from the busbar holder.

In at least one exemplary embodiment, at least one portion of an inner wall of the second hole is defined with the internal thread.

In this way, a length of the threaded connection between the busbar holder and the power terminal is increased, so the connection become more stable, and the power terminal is further prevented from being detached from the busbar holder.

In at least one exemplary embodiment, the internal thread defined by the inner wall of the first hole communicates with the internal thread defined by the inner wall of the second hole in the axial direction.

In this way, the threaded connection at the portion of the end of the power terminal near the busbar is lengthened, so the stability of the connection is further increased, and the power terminal is further prevented from being detached from the busbar holder.

In at least one exemplary embodiment, a diameter of a portion of the inner wall of the second hole where the internal thread is not defined is greater than a diameter of the internal thread.

In this way, the cylindrical portion is able to be easily removed from a mold after molding.

In at least one exemplary embodiment, a total length of the at least one portion of the second hole where the internal thread is defined in the axial direction is ½ or less of a total length of the second hole in the axial direction.

In this way, the cylindrical portion is able to be removed easily from the mold after molding.

In at least one exemplary embodiment, the resin portion further has a rib, and the rib is connected to an outer wall of the cylindrical portion and the base.

In this way, the strength of the cylindrical portion is reinforced by the rib, and the cylindrical portion is prevented from being damaged when the power terminal is screwed into the busbar holder.

In at least one exemplary embodiment, the resin portion has a plurality of cylindrical portions, and the rib is connected at least to opposing portions of the outer walls of the adjacent cylindrical portions and a portion of the base located between the adjacent cylindrical portions.

In this way, the strength of two cylindrical portions is reinforced by one rib, so costs are saved.

In at least one exemplary embodiment, a length of the at least one portion of the end of the power terminal where the external thread is defined in the axial direction is greater than a length of the at least one portion of the inner wall of the hole where the internal thread is defined in the axial direction.

In this way, an adjustment space is arranged for fine-adjusting an angle of the power terminal.

The above and other elements, features, steps, characteristics and advantages of the present disclosure will become more apparent from the following detailed description of the preferred embodiments with reference to the attached drawings.

### BRIEF DESCRIPTION OF THE DRAWINGS

The included drawings are used to provide a further understanding of the exemplary embodiments of the disclosure, which constitute a part of the specification, are used to illustrate the exemplary embodiments of the disclosure, and together with the text description, explain the principle of the disclosure. Obviously, the drawings in the following description are only some exemplary embodiments of the disclosure, and for a person having ordinary skill in the art, other drawings can be obtained based on these drawings without creative labor. In the drawings:

FIG. 1 is a schematic view of a motor according to an exemplary embodiment of the disclosure.

FIG. 2 is a schematic view of an implementation of a busbar holder and a power terminal of the motor according to an exemplary embodiment of the disclosure.

FIG. 3 is a partial cross-sectional local view of the busbar holder and the power terminal shown in FIG. 2 in an axial direction O.

FIG. 4 is an enlarged view of a portion A of the busbar holder and the power terminal shown in FIG. 2.

### DESCRIPTION OF THE EMBODIMENTS

With reference to the accompanying drawings, the foregoing and other features of the disclosure becomes apparent through the following description. In the specification and drawings, specific implementations of the disclosure are specifically disclosed, which indicate some implementations in which the principles of the disclosure may be adopted. It will be understood that the disclosure is not limited to the described implementations but includes all modifications, variations, and equivalents falling within the scope of the appended claims.

In the exemplary embodiments of the disclosure, the terms “first”, “second”, “up”, “down”, etc. are used to distinguish different elements in terms of appellations, but do not indicate the spatial arrangement or temporal order of these elements, and these elements should not be limited by these terms. The term “and/or” includes any and all combinations of one or more of the associated listed items. The terms such as “including” and “having” are intended to specify the presence of stated features, elements, devices, or components, but do not exclude the presence or addition of one or more other features, elements, devices, or components.

In the exemplary embodiments of the disclosure, the singular forms “a”, “the”, etc. are intended to include the plural forms and should be broadly understood as “a type” or “a class” rather than being limited to the meaning of “one”. In addition, the term “said” should be understood to include both singular and plural forms, unless the context clearly indicates otherwise. Besides, the term “according to” should be understood as “according at least in part to”, and the term “based on” should be understood as “based at least in part on”, unless the context clearly indicates otherwise.

In addition, in the following description of the disclosure, for the convenience of description, the direction along a central axis of a rotation shaft of a motor or the direction parallel to the central axis is referred to as an “axial direction O”. The radial direction centered on a line extending in the axial direction O is referred to as a “radial direction”. The side away from the centerline in a radius direction is referred to as a “radially outer side”. The side away close to the centerline in the radius direction is referred to as a “radially inner side”. The direction surrounding the axial direction O is referred to as a “circumferential direction”.

The exemplary embodiments of the disclosure are described in detail together with the accompanying figures.

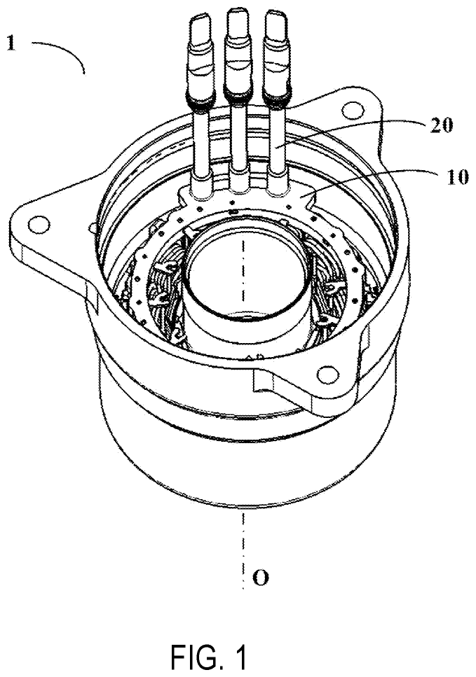

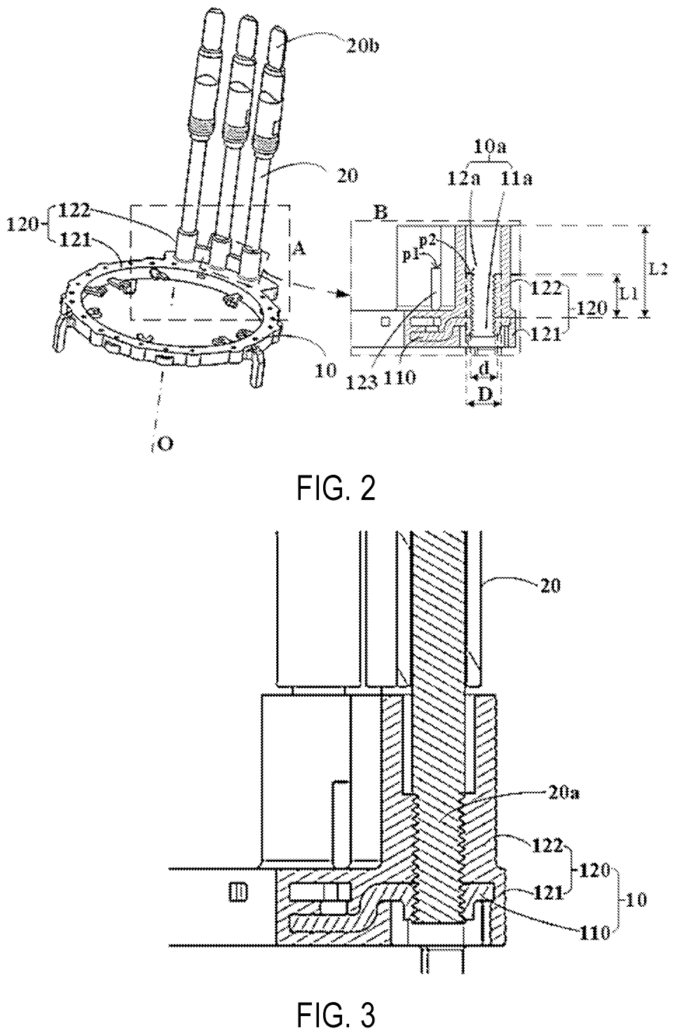

An exemplary embodiment of the disclosure provides a motor. FIG. 1 is a schematic view of a motor according to an exemplary embodiment of the disclosure, and part of a housing is hidden in this figure. FIG. 2 is a schematic view of an implementation of a busbar holder and a power terminal of the motor according to an exemplary embodiment of the disclosure. FIG. 3 is a partial cross-sectional local view of the busbar holder and the power terminal shown in FIG. 2 in an axial direction O.

As shown in FIG. 1, a motor 1 includes a busbar holder 10 and a power terminal 20, and the power terminal 20 is electrically connected to the busbar holder 10. For instance, the motor 1 is powered by connecting to an external power source through the power terminal 20.

In the exemplary embodiments of the disclosure, the motor 1 may also include other components, such as a casing, a stator, a rotor, a rotating shaft, etc. For details, reference may be made to related art, which are not limited in the exemplary embodiments of the disclosure.

Besides, in the exemplary embodiments of the disclosure, the power terminal 20 is, for example, a conductive bar made by a conductive material wrapped with an insulating material. The power terminal 20 is electrically connected to a busbar 110 (to be described in the following paragraphs) of the busbar holder 10 through the conductive bar.

As shown in FIG. 2, the cross-sectional view B is a cross-sectional view of a portion of the busbar holder 10 in the axial direction O. In at least one exemplary embodiment, as shown in the cross-sectional view B, the busbar holder 10 has a hole 10a, and at least one portion of an inner wall of the hole 10a is defined with an internal thread.

As shown in FIG. 3, an end 20a of the power terminal 20 is accommodated in the hole 10a (not shown in FIG. 3), and at least one portion of the end 20a of the power terminal 20 is defined with an external thread. The power terminal 20 and the busbar holder 10 are connected by threaded fitting of the external thread and the internal thread. In this way, the power terminal 20 is prevented from being detached from the busbar holder 10 through the threaded fitting between the power terminal 20 and the busbar holder 10.

In the exemplary embodiments of the disclosure, the “threaded fitting” means that the external thread of the power terminal 20 corresponds to each size of the internal thread of the busbar holder 10, and the two are able to be threadedly fitted. In the exemplary embodiments of the disclosure, the sizes of the threads are not limited, and the sizes may be accordingly set according to actual needs.

In addition, unless otherwise specified, the “internal thread” and the “external thread” described in the exemplary embodiments of the disclosure are threads extending helically in the axial direction O.

In addition, unless otherwise specified, the “internal thread” and the “external thread” described in the following paragraphs refer to threads capable of “threaded fitting”.

In addition, the power terminal 20 and the busbar holder 10 in the exemplary embodiments of the disclosure may be electrically connected through threaded fitting. For instance, the end 20a of the power terminal 20 is conductive. For instance, the end 20a of the power terminal 20 is an end of a conductive bar, and the end 20a of the power terminal 20 is electrically connected to the busbar 110 (to be described in the following paragraphs) of the busbar holder 10.

In addition, after the power terminal 20 and the busbar holder 10 are connected and fixed through threaded fitting, the power terminal 20 and the busbar holder 10 may further be fixed by welding. In this way, good electrical connection between the power terminal 20 and the busbar holder 10 is further ensured. Moreover, the fixing between the power terminal 20 and the busbar holder 10 may be further strengthened, so that the power terminal 20 is further prevented from being detached from the busbar holder 10.

In at least one exemplary embodiment, as shown in FIG. 2, the busbar holder 10 includes the busbar 110 and a resin portion 120 wrapping the busbar 110.

In at least one exemplary embodiment, the hole 10a is at least defined at the busbar 110, and a portion of the inner wall of the hole 10a located at the busbar 110 is defined with the internal thread. For instance, the resin portion 120 wraps only part of the busbar 110. A portion of the busbar 110 electrically connected to the power terminal 20 is exposed, and the hole 10a is defined in the exposed portion of the busbar 110, and the internal thread is defined on the inner wall of the hole 10a. In this way, the power terminal 20 is prevented from being detached from the busbar holder 10 through the threaded fitting between the power terminal 20 and the busbar 110.

In at least one exemplary embodiment, as shown in FIG. 2, the resin portion 120 has a base 121 wrapping the busbar 110 and a cylindrical portion 122 extending from the base 121 in the axial direction O. The hole 10a includes a first hole 11a defined in the busbar 110 and a second hole 12a defined in the cylindrical portion 122, and the first hole 11a and the second hole 23a pass through in the axial direction O.

In at least one exemplary embodiment, the internal thread may be defined merely on an inner wall of the first hole 11a. In this way, since the first hole 11a of the busbar 110 is welded and fixed to the power terminal 20 and the cylindrical portion 122 is used to keep the power terminal 20 from shifting and shaking in the axial direction O, the power terminal 20 is further prevented from being detached from the busbar holder 10.

In at least one exemplary embodiment, at least one portion of an inner wall of the second hole 12a may be defined with the internal thread. In this way, a length of the threaded connection between the busbar holder 10 and the power terminal 20 is increased, so the connection become more stable, and the power terminal 20 is further prevented from being detached from the busbar holder 10.

As shown in the cross-sectional view B of FIG. 2, the inner wall of the second hole 12a near the busbar 110 is defined with the internal thread, and the inner wall of the side away from the busbar 110 is not defined with the internal thread. However, the exemplary embodiments of the disclosure are not limited thereto, and the internal thread may also be defined on the entire inner wall of the second hole 12a. In this way, the power terminal 20 is further prevented from being detached from the busbar holder 10. Alternatively, the internal thread may be defined on the inner wall of the second hole 12a on the side away from the busbar 110, and no internal thread is defined on the inner wall on the side near the busbar 110.

In at least one exemplary embodiment, as shown in the cross-sectional view B, the internal thread defined by the inner wall of the first hole 11a communicates with the internal thread defined by the inner wall of the second hole 12a in the axial direction O. In this way, the threaded connection at the portion of the end 20a of the power terminal 20 near the busbar 110 is lengthened, so the stability of the connection is further increased, and the power terminal 20 is further prevented from being detached from the busbar holder 10.

In at least one exemplary embodiment, as shown in FIG. 2, a diameter D of a portion of the inner wall of the second hole 12a where the internal thread is not defined is greater than a diameter d of the internal thread. In the exemplary embodiments of the disclosure, the diameter d of the internal thread refers to the diameter corresponding to an outermost side of a tooth of the internal thread. In this way, the cylindrical portion 122 may be easily removed from a mold after molding.

Next, the cylindrical portion 122 is to be further described by taking the molding process of the cylindrical portion 122 as an example. A person having ordinary skill in the art shall understand that the molding process described in the following paragraphs is for the purpose of clarifying the structure of the cylindrical portion 122, and shall not be construed as limiting the implementation of the disclosure.

For instance, the cylindrical portion 122 is molding by using a molding jig, a front end of the molding jig has an external thread, and a rear end of the molding jig does not have the external thread. A diameter of a portion with the external thread at the front end is less than a diameter of a portion without the external thread at the rear end of the molding jig. The “front” and “rear” mentioned herein mean “front” and “rear” in the direction of insertion of the molding jig. It should be noted that the “front” and “rear” mentioned in the exemplary embodiments of the disclosure are only for a clearer description, and should not be interpreted as limitations on the implementation of the disclosure.

For instance, when the cylindrical portion 122 is molded, the external thread at the front end of the molding jig is fitted to the internal thread of the busbar 110. After pouring the resin and molding, because the diameter of the rear end of the molding jig is large, the front end of the molding jig with the external thread may be pulled out smoothly during demolding.

Besides, a length of the portion with the external thread at the front end of the molding jig in the axial direction may be equal to a length (also referred to as a “thickness”) of the busbar 110 in the axial direction and may also be longer than the length of the busbar 110 in the axial direction. In the exemplary embodiments of the disclosure, the length of the portion having the external thread at the front end of the molding jig in the axial direction is not limited.

In at least one exemplary embodiment, a total length L1 of the portion of the second hole 12a where the internal thread is defined in the axial direction O is ½ or less of a total length L2 of the second hole 12a in the axial direction O. In this way, the cylindrical portion 122 may be removed more easily from a mold after molding. Optionally, the length of the portion of the second hole 12a where the internal thread is defined in the axial direction may be as short as possible, so as to facilitate demolding of the cylindrical portion 122 after molding.

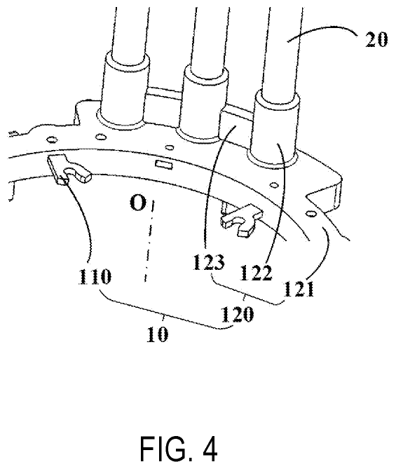

FIG. 4 is an enlarged view of a portion A of the busbar holder and the power terminal shown in FIG. 2.

In at least one exemplary embodiment, as shown in FIG. 4, the resin portion 120 may further have a rib 123, and the rib 123 is connected to an outer wall of the cylindrical portion 122 and the base 121. In this way, the strength of the cylindrical portion 122 is reinforced by the rib 123, and the cylindrical portion 122 is prevented from being damaged when the power terminal 20 is screwed into the busbar holder 10.

As shown in FIG. 4, in the exemplary embodiments of the disclosure, the rib 123 is strip-shaped or substantially strip-shaped or belt-shaped or substantially belt-shaped, but the exemplary embodiments of the disclosure are not limited thereto. The rib 123 may also be in other shapes, for example, a surface of the rib 123 parallel to the axial direction O may be triangular or substantially triangular, trapezoidal or substantially trapezoidal or the like. Besides, as shown in FIG. 4, for each cylindrical portion 122, one rib 123 may be arranged on an outer peripheral surface of the cylindrical portion 122, or a plurality of ribs 123 may be arranged on the outer peripheral surface of the cylindrical portion 122. The strength of the cylindrical portion 122 is further enhanced in this way.

In at least one exemplary embodiment, as shown in FIG. 2, a position p1 of an end of the rib 123 away from the base 121 in the axial direction is farther away from the base 121 than a position p2 of an end of the internal thread of the hole 10a away from the base 121 in the axial direction. For instance, a relative distance between the position p1 and the position p2 is a predetermined value. In the exemplary embodiment of the disclosure, a value of the predetermined value is not limited, and the value may be set according to actual needs, for example, the predetermined value is 3 mm to 5 mm. The strength of the cylindrical portion 122 is further enhanced in this way.

In at least one exemplary embodiment, the resin portion 120 has a plurality of cylindrical portions 122, and the rib 123 is connected at least to opposing portions of the outer walls of the adjacent cylindrical portions 122 and a portion of the base 121 located between the adjacent cylindrical portions 122. In this way, the strength of two cylindrical portions 122 is reinforced by one rib 123, so costs may be saved. In addition, as shown in FIG. 4, the rib 123 is not arranged on a circumferential outer side of the outermost cylindrical portion 122 in the circumferential direction, but the exemplary embodiments of the disclosure is not limited thereto, and the rib 123 may also be arranged on the circumferential outer side of the outermost cylindrical portion 122 in the circumferential direction. In this way, for each cylindrical portion 122, at least two opposite sides in the circumferential direction are individually fixed by the rib 123, so that the strength of the cylindrical portion 122 is further enhanced.

In at least one exemplary embodiment, for instance, as shown in FIG. 3, the length of the portion of the end 20a of the power terminal 20 where the external thread is defined in the axial direction may be greater than the length of the portion of the inner wall of the hole 10a (not shown in FIG. 3) where the internal thread is defined in the axial direction. In this way, an adjustment space is arranged for fine-adjusting an angle of the power terminal.

For instance, as shown in FIG. 2, a terminal 20b at the top of the power terminal 20 is flat. After the power terminal 20 rotates into the hole 10a of the busbar holder 10, if an orientation of the terminal 20b of the power terminal 20 does not match a direction to be connected, since the length of the internal thread of the end 20a of the power terminal 20 is longer, the power terminal 20 is able to continue to rotate to adjust the orientation of the terminal 20b.

According to the exemplary embodiments of the disclosure, the power terminal and the busbar holder are connected through threaded fitting, so that the stability of the electrical connection between the power terminal and the busbar holder is improved, and the failure rate of the motor is thus decreased.

Features of the above-described preferred embodiments and the modifications thereof may be combined appropriately as long as no conflict arises. While preferred embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

What is claimed is:

1. A motor, comprising a busbar holder and a power terminal electrically connected to the busbar holder, wherein
the busbar holder has a hole accommodating an end of the power terminal,
at least one portion of an inner wall of the hole is defined with an internal thread,
at least one portion of the end of the power terminal is defined with an external thread, and
the power terminal and the busbar holder are connected by threaded fitting of the external thread and the internal thread.

2. The motor according to in claim 1, wherein
the busbar holder comprises a busbar and a resin portion wrapping the busbar,
the hole is at least defined at the busbar, and a portion of the inner wall of the hole located at the busbar is defined with the internal thread.

3. The motor according to in claim 2, wherein
the resin portion has a base wrapping the busbar and a cylindrical portion extending from the base in an axial direction,
the hole comprises a first hole defined in the busbar and a second hole defined in the cylindrical portion,
the first hole and the second hole pass through in the axial direction, and
an inner wall of the first hole is defined with the internal thread.

4. The motor according to in claim 3, wherein
at least one portion of an inner wall of the second hole is defined with the internal thread.

5. The motor according to in claim 4, wherein
the internal thread defined by the inner wall of the first hole communicates with the internal thread defined by the inner wall of the second hole in the axial direction.

6. The motor according to in claim 5, wherein
a diameter of a portion of the inner wall of the second hole where the internal thread is not defined is greater than a diameter of the internal thread.

7. The motor according to in claim 5, wherein
a total length of the at least one portion of the second hole where the internal thread is defined in the axial direction is ½ or less of a total length of the second hole in the axial direction.

8. The motor according to in claim 5, wherein
the resin portion further has a rib, and the rib is connected to an outer wall of the cylindrical portion and the base.

9. The motor according to in claim 8, wherein
the resin portion has a plurality of cylindrical portions, and the rib is connected at least to opposing portions of the outer walls of the adjacent cylindrical portions and a portion of the base located between the adjacent cylindrical portions.

10. The motor according to claim 1, wherein
a length of the at least one portion of the end of the power terminal where the external thread is defined in the axial direction is greater than a length of the at least one portion of the inner wall of the hole where the internal thread is defined in the axial direction.
